(19) United States
(12) Patent Application Publication
(10) Pub. No.: US 2022/0073059 A1
(43) Pub. Date: Mar. 10, 2022

(54) PARKING LOT SYSTEM, MANAGEMENT DEVICE, AND PARKING LOT FACILITY

(71) Applicant: DENSO CORPORATION, Kariya-city (JP)

(72) Inventor: Koudai YAMAURA, Kariya-city (JP)

(21) Appl. No.: 17/531,390

(22) Filed: Nov. 19, 2021

Related U.S. Application Data
(63) Continuation of application No. PCT/JP2020/020178, filed on May 21, 2020.

(30) Foreign Application Priority Data
May 24, 2019 (JP) 2019-097815

(51) Int. Cl. B60W 30/06; G08G 1/14; G08G 1/01

(52) U.S. Cl. CPC B60W 30/06; G08G 1/148; G08G 1/146; B60W 2556/50; G08G 1/0112; B60W 2556/10; G08G 1/0129

(57) ABSTRACT

A parking lot system includes an entering place, a leaving place, a space, an automated guided vehicle, and a management device. The management device sets, in the space, a parking lot, a first passage connecting the entering place to the leaving place through the parking lot, and a second passage connecting the leaving place to the entering place. The management device causes the automated guided vehicle to transport a vehicle from the entering place to the parking lot and to transport the vehicle from the parking lot to the leaving place. The management device further causes the automated guided vehicle to move from the leaving place to the entering place. The first passage and the second passage are divided from each other.

### CROSS REFERENCE TO RELATED APPLICATIONS

The present application is a continuation application of International Patent Application No. PCT/JP2020/020178 filed on May 21, 2020, which designated the U.S. and claims the benefit of priority from Japanese Patent Application No. 2019-097815 filed on May 24, 2019. The entire disclosures of all of the above applications are incorporated herein by reference.

### TECHNICAL FIELD

The present disclosure relates to a parking lot system, a management device, and a parking lot facility.

### BACKGROUND

There has been known an automatic parking management system in which an automated guided vehicle is used to transport a vehicle to a parking lot.

### SUMMARY

The present disclosure provides a parking lot system, a management device, and a parking lot facility in which a first passage connecting an entering place to a leaving place through a parking lot, and a second passage connecting the leaving place to the entering place are divided from each other.

### BRIEF DESCRIPTION OF DRAWINGS

Objects, features and advantages of the present disclosure will become apparent from the following detailed description made with reference to the accompanying drawings. In the drawings:

FIG. 1 is an explanatory diagram showing a configuration of a parking lot system;

FIG. 2 is a block diagram showing a configuration of a management device, an automated guided vehicle, and a vehicle having an automated valet function;

FIG. 3 is a block diagram showing a functional configuration of a controller included in the management device;

FIG. 4 is a flowchart showing a first parking control process executed by the management device;

FIG. 5 is a flowchart showing a first parking execution process executed by the automated guided vehicle;

FIG. 6 is a flowchart showing a first leaving control process executed by the management device;

FIG. 7 is a flowchart showing a first leaving execution process executed by the automated guided vehicle;

FIG. 8 is a flowchart showing a second leaving control process executed by the management device;

FIG. 9 is a flowchart showing a second leaving execution process executed by the vehicle having the automated valet function; and

FIG. 10 is an explanatory diagram showing a configuration of a parking lot system according to another embodiment.

### DETAILED DESCRIPTION

A parking lot system may have a configuration in which an automated guided vehicle is used to transport a vehicle from an entering place to a parking lot, and to transport the vehicle from the parking lot to a leaving place. After transporting the vehicle from the parking lot to the leaving place, the automated guided vehicle separated from the vehicle moves to the entering place.

However, as a result of detailed examination by the inventor, the following issues have been found. In the case of the above parking lot system, if an automated guided vehicle that is transporting a vehicle and an automated guided vehicle that is moving from the leaving place to the entering place are mixed on one passage, congestion occurs. As a result, it becomes difficult for the parking lot system to efficiently park and leave vehicles.

A parking lot system according to a first aspect of the present disclosure includes an entering place, a leaving place, a space, an automated guided vehicle configured to transport a vehicle, and a management device configured to control the automated guided vehicle. The management device includes a setting unit, a transport control unit, and a movement control unit. The setting unit is configured to set, in the space, a parking lot, a first passage connecting the entering place to the leaving place through the parking lot, and a second passage connecting the leaving place to the entering place. The transport control unit is configured to cause the automated guide vehicle to transport the vehicle from the entering place to the parking lot through at least a part of the first passage, and transport the vehicle from the parking lot to the leaving place through at least another part of the first passage. The movement control unit is configured to cause the automated guided vehicle to travel from the leaving place to the entering place through the second passage. The first passage and the second passage are divided from each other.

In the parking lot system according to the first aspect of the present disclosure, the automated guided vehicle that is transporting the vehicle to the parking lot travels on the first passage. In addition, the automated guided vehicle that is transporting the vehicle to the leaving place also travels on the first passage.

In the parking lot system according to the first aspect of the present disclosure, the automated guided vehicle that is separated from the vehicle and is moving from the leaving place to the entering place travels on the second passage. The first passage and the second passage are divided from each other.

Therefore, according to the parking lot system according to the first aspect of the present disclosure, the automated guided vehicle that is transporting the vehicle and the automated guided vehicle that is separated from the vehicle are less likely to travel on the same passage. As a result, the parking lot system according to the first aspect of the present disclosure can suppress congestion in the first passage and the second passage, and can efficiently park and leave the vehicle.

A management device according to a second aspect of the present disclosure is for managing an automated valet parking using an automated guided vehicle capable of transporting a vehicle in a parking lot facility that includes an entering place, a leaving place, and a space.

The management device includes a setting unit, a transport control unit, and a movement control unit. The setting unit is configured to set, in the space, a parking lot, a first passage connecting the entering place to the leaving place through the parking lot, and a second passage connecting the leaving place to the entering place. The transport control unit is configured to cause the automated guide vehicle to transport the vehicle from the entering place to the parking lot through at least a part of the first passage, and transport the vehicle from the parking lot to the leaving place through at least another part of the first passage. The movement control unit is configured to cause the automated guided vehicle to travel from the leaving place to the entering place through the second passage. The first passage and the second passage are divided from each other.

The management device according to the second aspect of the present disclosure can set the first passage and the second passage. The automated guided vehicle that is transporting the vehicle to the parking lot travels on the first passage. In addition, the automated guided vehicle that is transporting the vehicle to the leaving place also travels on the first passage. The automated guided vehicle that is separated from the vehicle and is moving from the leaving place to the entering place travels on the second passage. The first passage and the second passage are divided from each other.

Therefore, according to the management device according to the second aspect of the present disclosure, the automated guided vehicle that is transporting the vehicle and the automated guided vehicle that is separated from the vehicle are less likely to travel on the same passage. As a result, the management device according to the second aspect of the present disclosure can suppress congestion in the first passage and the second passage, and can efficiently park and leave the vehicle.

A parking lot facility according to a third aspect of the present disclosure is a facility in which automated valet parking using an automated guided vehicle capable of transporting a vehicle is managed by a management device

The parking lot facility includes an entering place, a leaving place, a parking lot, a first passage and a second passage. The first passage connects the entering place to the leaving place through the parking lot, and is a passage on which the automated guided vehicle travels when transporting the vehicle from the leaving place to the parking lot, and when transporting the vehicle from the parking lot to the leaving place. The second passage connects the leaving place to the entering place, is divided from the first passage, and is a passage on which automated guided vehicle travels when moving from the leaving place to the entering place.

The parking lot facility according to the third aspect of the present disclosure can set the first passage and the second passage. The automated guided vehicle that is transporting the vehicle to the parking lot travels on the first passage. In addition, the automated guided vehicle that is transporting the vehicle to the leaving place also travels on the first passage. The automated guided vehicle that is separated from the vehicle and is moving from the leaving place to the entering place travels on the second passage. The first passage and the second passage are divided from each other.

Therefore, according to the parking lot facility according to the third aspect of the present disclosure, the automated guided vehicle that is transporting the vehicle and the automated guided vehicle that is separated from the vehicle are less likely to travel on the same passage. As a result, the parking lot facility according to the third aspect of the present disclosure can suppress congestion in the first passage and the second passage, and can efficiently park and leave the vehicle.

Hereinafter, embodiments of the present disclosure will be described with reference to the drawings.

### First Embodiment

1. Configuration of a Parking Lot System 1

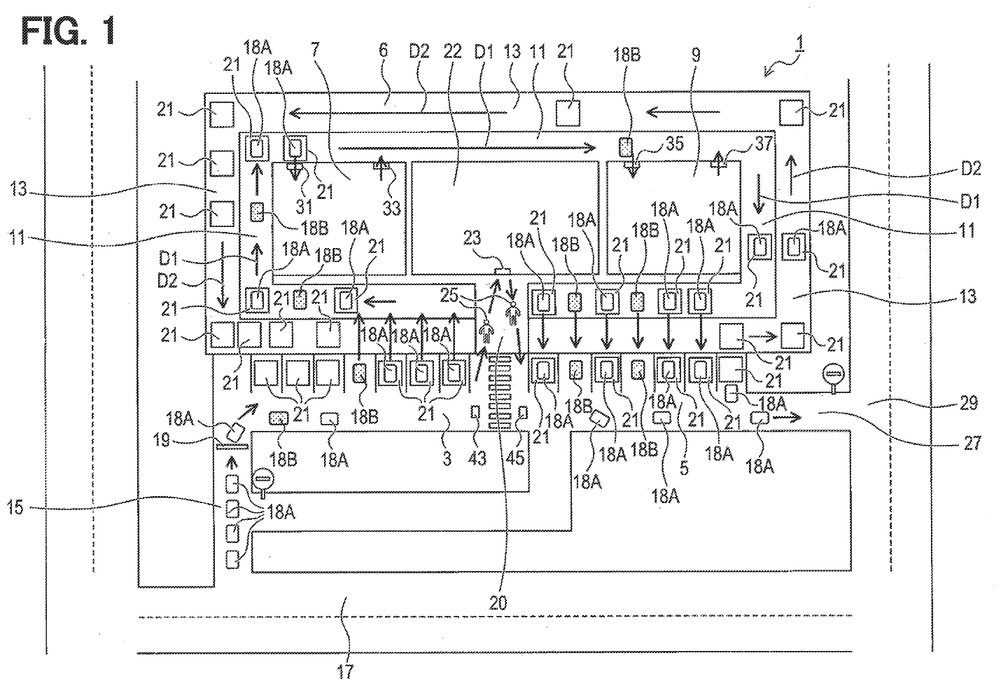

A configuration of a parking lot system 1 will be described with reference to FIGS. 1 to 3. As shown in FIG. 1, the parking lot system 1 includes an entering place 3, a leaving place 5, and a space 6. The entering place 3, the leaving place 5, and the space 6 correspond to parking lot facilities. The space 6 is adjacent to the entering place 3 and the leaving place 5. For example, a store 22 is present in a part of the space 6. The store 22 corresponds to a facility. In the space 6, as will be described later, a first parking lot 7, a second parking lot 9, a first passage 11, and a second passage 13 are virtually set. That is, in FIG. 1, for convenience, the first parking lot 7, the second parking lot 9, the first passage 11, and the second passage 13 are shown by being separated by a solid line, but the actual road surface does not have to be separated by a white line or the like.

The entering place 3 is connected to a public road 17 through an entrance 15. Vehicles 18 can enter the entering place 3 from the public road 17 through the entrance 15. The vehicles 18 include vehicles 18A having no automated valet function and vehicles 18B having an automated valet function. The automated valet function is a function of traveling from the entering place 3 to the first parking lot 7 or the second parking lot 9 and parking by autonomous driving, and the function of traveling from the first parking lot 7 or the second parking lot 9 to the leaving place 5 by autonomous driving.

A gate 19 is provided at the entrance 15. The gate 19 has an open state and a closed state. When the gate 19 is open, the vehicles 18 can pass through the entrance 15. When the gate 19 is closed, the vehicles 18 cannot pass through the entrance 15.

Multiple automated guided vehicles 21 are arranged at the entering place 3. The configuration of the automated guided vehicles 21 will be described later. The entering place 3 and an entrance 23 of the store 22 are connected by a pedestrian-only area 20. An occupant 25 of a vehicle 18 that has entered the entering place 3 can get off from the vehicle 18, pass through the pedestrian-only area 20, and proceed to the entrance 23 on foot.

The leaving place 5 is connected to a public road 29 through an exit 27. The vehicles 18 can proceed from the leaving place 5 to the public road 29 through the exit 27. The leaving place 5 and the entrance 23 are connected by the pedestrian-only area 20. The occupant 25 can walk from the entrance 23 to the leaving place 5 through the pedestrian-only area 20.

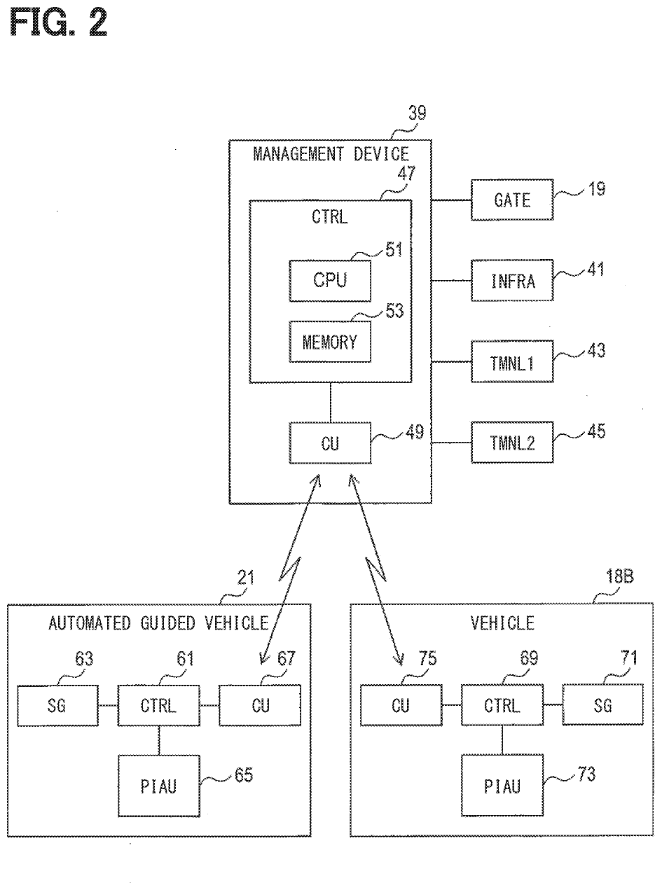

As shown in FIG. 2, the parking lot system 1 includes a management device 39, an infrastructure (INFRA) 41, a first terminal (TMNL1) 43, and a second terminal (TMNL2) 45.

The management device 39 includes a controller (CTRL) 47 and a communication unit (CU) 49. The controller 47 includes a microcomputer having a CPU 51 and a semiconductor memory (hereinafter, a memory 53) such as a RAM or a ROM, for example.

Functions provided by the controller 47 are implemented by the CPU 51 executing a program stored in a non-transitory tangible storage medium. In this example, the memory 53 corresponds to the non-transitory tangible storage medium storing the program. When the program is executed, a method corresponding to the program is executed. The controller 47 may include one or more microcomputers.

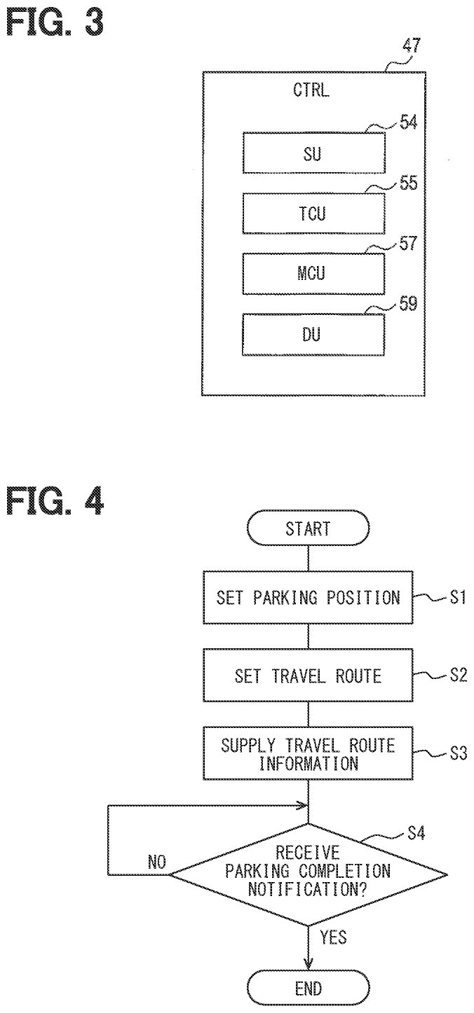

As shown in FIG. 3, the controller 47 includes a setting unit (SU) 54, a transport control unit (TCU) 55, a movement control unit (MCU) 57, and a detection unit (DU) 59.

The setting unit 54 virtually sets the first parking lot 7, the second parking lot 9, the first passage 11, and the second passage 13 in the space 6. The transport control unit 55 uses the automated guided vehicle 21 to transport the vehicle 18 from the entering place 3 to the first parking lot 7 or the second parking lot 9 through at least a part of the first passage 11, and transport the vehicle 18 from the first parking lot 7 or the second parking lot 9 to the leaving place 5 through at least a part of the first passage 11. The movement control unit 57 moves the automated guided vehicle 21 from the leaving place 5 to the entering place 3 through the second passage 13.

The memory 53 stores map information inside the parking lot system 1. The map information includes information indicating positions of obstacles. Further, the map information includes information indicating the state of sections in the first parking lot 7 and the second parking lot 9. The state of the section includes a state where the section is vacant (hereinafter, referred to as a vacant state) and a state where the section is occupied by the vehicle 18 (hereinafter, referred to as an occupied state).

The communication unit 49 can communicate with the automated guided vehicle 21 and the vehicle 18B. The communication interface between the communication unit 49 and the automated guided vehicle 21 and the communication interface between the communication unit 49 and the vehicle 18B are the same.

The management device 39 can control the gate 19. When there are few vacant sections in the first parking lot 7 and the second parking lot 9, the management device 39 closes the gate 19. When there are enough vacant sections in the first parking lot 7 and the second parking lot 9, the management device 39 opens the gate 19.

The infrastructure 41 acquires information representing the internal state of the parking lot system 1 (hereinafter referred to as parking lot information), and supplies the parking lot information to the management device 39. The infrastructure 41 includes a camera or the like that photographs the inside of the parking lot system 1. Examples of the parking lot information include information indicating the position of an obstacle, information indicating the states of the sections in the first parking lot 7 and the second parking lot 9, and the like.

As shown in FIG. 1, the first terminal 43 is installed at the entering place 3. The first terminal 43 receives an input operation by the occupant 25. The first terminal 43 outputs a signal corresponding to the input operation to the management device 39. The first terminal 43 outputs a parking request signal, for example, in response to the input operation. The parking request signal is a signal that requests to transport the vehicle 18 at the entering place 3 to the first parking lot 7 or the second parking lot 9 and park the vehicle 18. Further, the first terminal 43 outputs identification information of the automated guided vehicle 21 or the vehicle 18 in response to the input operation, for example.

As shown in FIG. 1, the second terminal 45 is installed at the leaving place 5. The second terminal 45 receives an input operation by the occupant 25. The second terminal 45 outputs a signal corresponding to the input operation to the management device 39.

The second terminal 45 outputs, for example, an exit request signal, a re-parking request signal, and the like in response to the input operation. The exit request signal is a signal that requests to transport the vehicle 18 parked in the first parking lot 7 or the second parking lot 9 to the leaving place 5. The re-parking request signal is a signal that requests to return the vehicle 18 transported to the leaving place 5 to the first parking lot 7 or the second parking lot 9 and park again. Further, the second terminal 45 outputs identification information of the automated guided vehicle 21 or the vehicle 18 in response to the input operation, for example.

The automated guided vehicle 21 can, for example, travel in a state in which the vehicle 18 is mounted above the automated guided vehicle 21 (hereinafter, referred to as a mounting state). In addition, the automated guided vehicle 21 has a function of automatically driving to a target position along a travel route. The automated guided vehicle 21 can transport the vehicle 18 to the target position by automatically driving to the target position along the travel route in the mounting state.

As shown in FIG. 2, the automated guided vehicle 21 includes a controller (CTRL) 61, a sensor group (SG) 63, a positioning information acquisition unit (PIAU) 65, and a communication unit (CU) 67.

The controller 61 controls each unit of the automated guided vehicle 21. The function of the automated driving is realized by the control performed by the controller 61. The controller 61 holds map information inside the parking lot system 1. The automated guided vehicle 21 uses the map information, for example, when performing autonomous driving.

The automated guided vehicle 21 does not have to use the map information. For example, a two-dimensional bar code is drawn on a floor of the parking lot system 1 at predetermined intervals. The automated guided vehicle 21 is provided with a camera on a lower surface thereof. The automated guided vehicle 21 recognizes the position of the automated guided vehicle 21 while reading the two-dimensional bar code using the camera, and receives a route instruction from the management device 39. Examples of the two-dimensional bar code include a QR code (registered trademark) and the like.

The sensor group 63 acquires peripheral information representing the situation around the automated guided vehicle 21. Examples of the contents of the peripheral information include a position of an obstacle present around the automated guided vehicle 21. The sensor group 63 includes a camera, a LiDAR, and the like. The automated guided vehicle 21 uses peripheral information when performing autonomous driving.

The position information acquisition unit 65 acquires position information of the automated guided vehicle 21. The position information acquisition unit 65 is a GPU system, for example. The automated guided vehicle 21 uses the position information when performing autonomous driving. The communication unit 67 can communicate with the management device 39.

The vehicle 18B has the automated valet function as described above. As shown in FIG. 2, the vehicle 18B includes a controller (CTRL) 69, a sensor group (SG) 71, a position information acquisition unit (PIAU) 73, and a communication unit (CU) 75.

The controller 69 controls each unit of the vehicle 18B. The function of the autonomous driving is realized by the control performed by the controller 69. The vehicle 18B acquires the map information inside the parking lot system 1 from the management device 39. The vehicle 18B uses the map information acquired from the management device 39 when performing autonomous driving.

The sensor group 71 acquires peripheral information representing the situation around the vehicle 18B. Examples of the contents of the peripheral information include a position of an obstacle present around the vehicle 18B. The sensor group 71 includes a camera, a LiDAR, and the like. The vehicle 18B uses peripheral information when performing autonomous driving.

The position information acquisition unit 73 acquires position information of the vehicle 18B. The position information acquisition unit 73 is a GPU system, for example. The vehicle 18B uses the position information when performing autonomous driving. The communication unit 75 can communicate with the management device 39.

2. Setting process of the first parking lot 7, the second parking lot 9, the first passage 11, and the second passage 13

The setting unit 54 of the management device 39 uses the map information stored in the memory 53 to virtually setting the first parking lot 7, the second parking lot 9, the first passage 11, and the second passage 13 in the space 6. That is, the setting unit 54 can optionally set which area is used for what purpose by using the map information of the space 6.

Each of the first parking lot 7 and the second parking lot 9 is a place where multiple vehicles 18 can be parked. The first parking lot 7 and the second parking lot 9 are adjacent to the store 22.

The setting unit 54 sets coordinates of multiple sections inside the first parking lot 7 on the map. As a result, the setting unit 54 virtually provides multiple sections inside the first parking lot 7. Each section is an area where one vehicle 18 can be parked. In a manner similar to the first parking lot 7, the setting unit 54 virtually provides multiple sections inside the second parking lot 9. The setting unit 54 sets an entrance 31 and an exit 33 of the first parking lot 7 on the map, and sets an entrance 35 and an exit 37 of the second parking lot 9 on the map.

The setting unit 54 sets a passage from the entering place 3 to the leaving place 5 through the first parking lot 7 and the second parking lot 9 as the first passage 11. The setting unit 54 sets the entrance 31, the exit 33, the entrance 35, and the exit 37 at positions facing the first passage 11. The vehicle 18 and the automated guided vehicle 21 having the autonomous driving function can travel in the first passage 11. The setting unit 54 sets the width of the first passage 11 to be larger than the width of the vehicle 18 and not more than twice the width of the vehicle 18. Alternatively, the width of the first passage 11 may be larger than the width of the automated guided vehicle 21 and not more than twice the width of the automated guided vehicle 21. For example, as shown in FIG. 1, the setting unit 54 sets the first passage 11 so as to surround the first parking lot 7, the second parking lot 9, and the store 22.

The setting unit 54 sets a passage from the leaving place 5 to the entering place 3 as the second passage 13. The vehicle 18 and the automated guided vehicle 21 can travel in the second passage 13. The setting unit 54 sets the width of the second passage 13 to be larger than the width of the vehicle 18 and not more than twice the width of the vehicle 18. Alternatively, the width of the second passage 13 may be larger than the width of the automated guided vehicle 21 and equal to or less than twice the width of the automated guided vehicle 21. For example, as shown in FIG. 1, the setting unit 54 sets the second passage 13 so as to surround the first passage 11 while being adjacent to the first passage 11.

3. First parking control process executed by the management device 39

A first parking control process executed by the management device 39 will be described with reference to FIG. 4. In the first parking control process, the automated guided vehicle 21 is used to transport the vehicle 18 from the entering place 3 to the first parking lot 7 or the second parking lot 9 through a part of the first passage 11 and to park the vehicle 18.

The first parking control process is started when the first terminal 43 outputs the parking request signal and the identification information of the automated guided vehicle 21 used for transporting the vehicle 18 to the management device 39.

The situation when the first terminal 43 outputs the parking request signal and the identification information of the automated guided vehicle 21 to the management device 39 is as follows, for example. The vehicle 18 to be parked enters the entering place 3 and is mounted above the automated guided vehicle 21.

The automated guided vehicle 21 inserts, for example, a plate-shaped member below the vehicle 18, and then lifts the plate-shaped member. As a result, the vehicle 18 is placed on the automated guided vehicle 21. In another example, the vehicle 18 moves on a base. The automated guided vehicle 21 slides under the base. Next, the automated guided vehicle 21 lifts the base and the vehicle 18. As a result, the vehicle 18 is mounted above the automated guided vehicle 21.

Next, the occupant 25 gets off the vehicle 18 and performs an input operation corresponding to the parking request signal to the first terminal 43, and inputs the identification information of the automated guided vehicle 21 used for transporting the vehicle 18.

In the following description of the first parking control process and the description of the first parking execution process described later, the automated guided vehicle 21 is the automated guided vehicle 21 corresponding to the input identification information unless otherwise specified.

In S1 of FIG. 4, the transport control unit 55 and the detection unit 59 select a parking position using the map information of the space 6 stored in the memory 53. The detection unit 59 manages, for each section in the first parking lot 7 or the second parking lot 9, the identification information, position coordinates on the map, and whether or not the section is vacant. The parking position to be selected is a section in the first parking lot 7 or the second parking lot 9 that is in the vacant state. The detection unit 59 determines the state of each section as follows, for example. The state of each section corresponds to the state of the parking lot. When the vehicle 18 parks in a certain section, the vehicle 18 sends the identification information of the section and parking start information to the management device 39. Further, when the vehicle 18 leaves the section in which the vehicle has been parked, the vehicle 18 sends the identification information of the section and parking end information to the management device 39. The parking end is, for example, the completion of leaving of the vehicle 18 from the section.

The detection unit 59 determines the state of each section based on the history of information sent from the vehicle 18. Further, the detection unit 59 may determine the state of each section based on the information supplied by the infrastructure 41.

When there is only one vacant section, the transport control unit 55 sets that section as the parking position. When there are multiple vacant sections, the transport control unit 55 selects one section as the parking position from the multiple vacant sections based on a predetermined criteria. Examples of the criteria include selecting the section closest to the entering place 3, selecting the section closest to the leaving place 5, and selecting the section in an area where the vacant sections are gathered.

When all the sections are occupied, the transport control unit 55 sets the area on the first passage 11 or the second passage 13 as the parking position.

In S3, the transport control unit 55 transmits information representing a travel route set in S2 (hereinafter referred to as travel route information) using the communication unit 49. As will be described later, the automated guided vehicle 21 receives the travel route information.

In S4, the transport control unit 55 determines whether or not the communication unit 49 has received parking completion notification. The parking completion notification is a notification transmitted by the automated guided vehicle 21 when the automated guided vehicle 21 is parked at the parking position. When the parking completion notification has been received, this process ends. If the parking completion notification has not been received, this process returns to a state before S4.

4. First Parking Execution Process Executed by the Automated Guided Vehicle 21

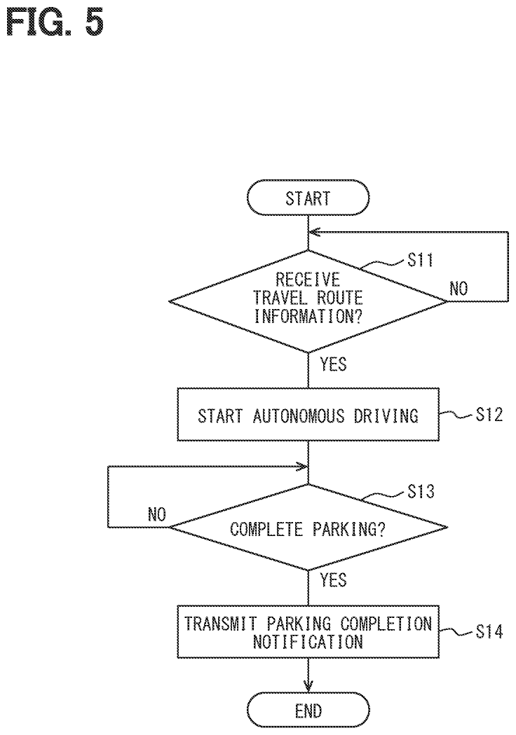

The first parking execution process executed by the automated guided vehicle 21 will be described with reference to FIG. 5. The first parking execution process is a process of transporting the vehicle 18 from the entering place 3 to the parking position in response to the first parking control process.

In S11, the controller 61 determines whether or not the communication unit 67 has received the travel route information. The travel route information is transmitted by the management device 39 in S3. When the travel route information has been received, the process proceeds to S12. When the travel route information has not been received, the process returns to a state before S11.

In S12, the controller 61 starts the autonomous driving by using the travel route information and the map information held in advance. By the autonomous driving, the automated guided vehicle 21 travels in the first passage 11. The direction in which the automated guided vehicle 21 travels is always a first direction D1 shown in FIG. 1. The automated guided vehicle 21 is in the mounting state.

In S13, the controller 61 determines whether the parking has completed. When parking is completed, the automated guided vehicle 21 and the vehicle 18 are parked at the parking position. When the parking has been completed, the process proceeds to S14. When the parking has not completed, the process returns to a state before S13.

In S14, the controller 61 transmits the parking completion notification using the communication unit 67. The management device 39 receives the transmitted parking completion notification. After the parking has completed, the automated guided vehicle 21 heads for, for example, the vehicle 18 to be transported next, or is charged.

5. First Leaving Control Process Executed by the Management Device 39

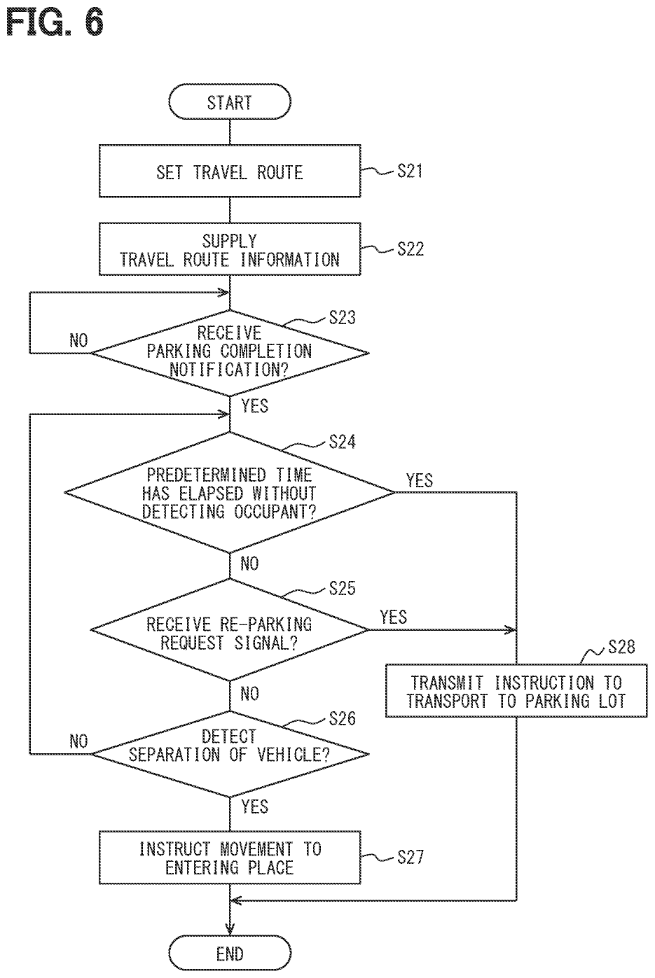

A first issue control process executed by the management device 39 will be described with reference to FIG. 6. The first leaving control process is a process of transporting the vehicle 18 from the parking position to the leaving place 5 through at least a part of the first passage 11 by using the automated guided vehicle 21.

The first leaving control process is started when the management device 39 determines that a trigger for leaving has occurred. Examples of cases where the management device 39 determines that the trigger for leaving has occurred include the following first situation and second situation.

(First Situation)

The occupant 25 inputs the identification information of the vehicle 18 to leave to the second terminal 45 to perform an input operation corresponding to the leaving request signal, and inputs the identification information of the automated guided vehicle 21 used for transporting the vehicle 18. The second terminal 45 outputs the leaving request signal and the identification information of the automated guided vehicle 21 to the management device 39. The management device 39 determines that the trigger for leaving has occurred.

(Second Situation)

The occupant 25 inputs the identification information of the vehicle 18 to leave to the management device 39 using a mobile terminal or the like, and makes a reservation for leaving. The reservation for leaving is made by designating a reservation time for leaving and the identification information of the automated guided vehicle 21. When the reserved time arrives, the management device 39 determines that the trigger for leaving has occurred.

In the following description of the first leaving control process and the description of the first leaving execution process described later, the automated guided vehicle 21 is the automated guided vehicle 21 corresponding to the input identification information and the vehicle 18 is the vehicle 18 corresponding to the input identification information unless otherwise specified.

In S21, the transport control unit 55 sets a travel route for moving from the current position of the automated guided vehicle 21 to the leaving place 5 through the parking position of the vehicle 18 by using the map information. For example, when the current position of the automated guided vehicle 21 is near the leaving place 5, the transport control unit 55 sets a first travel route that enters the second parking lot 9 through the second passage 13 and heads for the parking position of the vehicle 18, and a second travel route that heads for the leaving place 5 from the parking position of the vehicle 18 through the first passage 11. The transport control unit 55 sets a route traveling through the center of the first passage 11 and the center of the second passage 13 as travel routes.

Similarly, when the current position of the automated guided vehicle 21 is, for example, the first passage 11, the second passage 13, the entering place 3, the first parking lot 7, or the second parking lot 9, the transport control unit 55 sets a first travel route that enters the first parking lot 7 or the second parking lot 9 from the current position of the automated guided vehicle 21 through the first passage 11 or the second passage 13 and heads for the parking position of the vehicle 18, and a second travel route that heads for the leaving place 5 from the parking position of the vehicle 18 through the first passage 11.

When the current position of the automated guided vehicle 21 is the entering place 3, the transport control unit 55 sets a first travel route that enters the first parking lot 7 or the second parking lot 9 from the current position of the automated guided vehicle 21 through the first passage 11 and heads for the parking position of the vehicle 18.

In S22, the transport control unit 55 transmits travel route information representing the travel route set in S21 to the automated guided vehicle 21 using the communication unit 49. As will be described later, the automated guided vehicle 21 receives the travel route information.

In S23, the movement control unit 57 determines whether or not the communication unit 49 has received an arrival notification. The arrival notification is a notification transmitted by the automated guided vehicle 21 when the automated guided vehicle 21 arrives at the leaving place 5. When the arrival notification has been received, the process proceeds to S24. When the arrival notification has not been received, the process returns to a state before S23.

In S24, the movement control unit 57 determines whether or not a predetermined time has elapsed from a time when the arrival notification is received without detecting the occupant 25 at the leaving place 5. The movement control unit 57 can detect the occupant 25 by using the infrastructure 41. When the predetermined time has elapsed from the time when the arrival notification is received without detecting the occupant 25 at the leaving place 5, the process proceeds to S28. When the occupant 25 is detected or the predetermined time has not yet elapsed, the process proceeds to S25.

In S25, the movement control unit 57 determines whether or not the re-parking request signal or the like has been received from the second terminal 45. When the re-parking request signal or the like has been received, the process proceeds to S28. When the re-parking request signal or the like has not been received, the process proceeds to S26. The re-parking request signal is a signal output by the second terminal 45 to the management device 39 in response to an input operation by a user.

In S26, the movement control unit 57 determines whether or not the vehicle 18 previously mounted above the automated guided vehicle 21 has left the leaving place 5, or whether or not the vehicle 18 previously mounted above the automated guided vehicle 21 is separated from the automated guided vehicle 21. The movement control unit 57 can detect that the vehicle 18 has left the leaving place 5 by using the infrastructure 41. When the vehicle 18 has left the leaving place 5, the process proceeds to S27. When the vehicle 18 has not yet left the leaving place 5, the process proceeds to S24.

In S27, the movement control unit 57 transmits an instruction to move to the entering place 3 to the automated guided vehicle 21 that is separated from the vehicle 18 by using the communication unit 49. For example, the movement control unit 57 transmits, to the automated guided vehicle 21, travel route information indicating a travel route from the leaving place 5 which is the current position of the automated guided vehicle 21 to the entering place 3 through the second passage 13. Here, the moving instruction to the entering place 3 is transmitted by assuming that a waiting place of the automated guided vehicle 21 is the vicinity of the entering place 3, but for example, the movement control unit 57 may also transmit a moving instruction to the first parking lot 7 or a waiting place in the vicinity of the first parking lot 7.

Further, the waiting place can be, for example, the vicinity of the leaving place 5. When the waiting place is in the vicinity of the leaving place 5, the automated guided vehicle 21 that has been waiting can go to the parking position through the second passage 13 when there is the leaving request signal. The waiting place is a position where the automated guided vehicle 21 is present when the automated guided vehicle 21 is not in use. When the automated guided vehicle 21 is not in use is when the instruction for entering or leaving is not sent to the automated guided vehicle 21.

In S28, the movement control unit 57 transmits, to the automated guided vehicle 21, an instruction to transport the vehicle 18 to the first parking lot 7 or the second parking lot 9 by using the communication unit 49.

6. First Leaving Execution Process Executed by the Automated Guided Vehicle 21

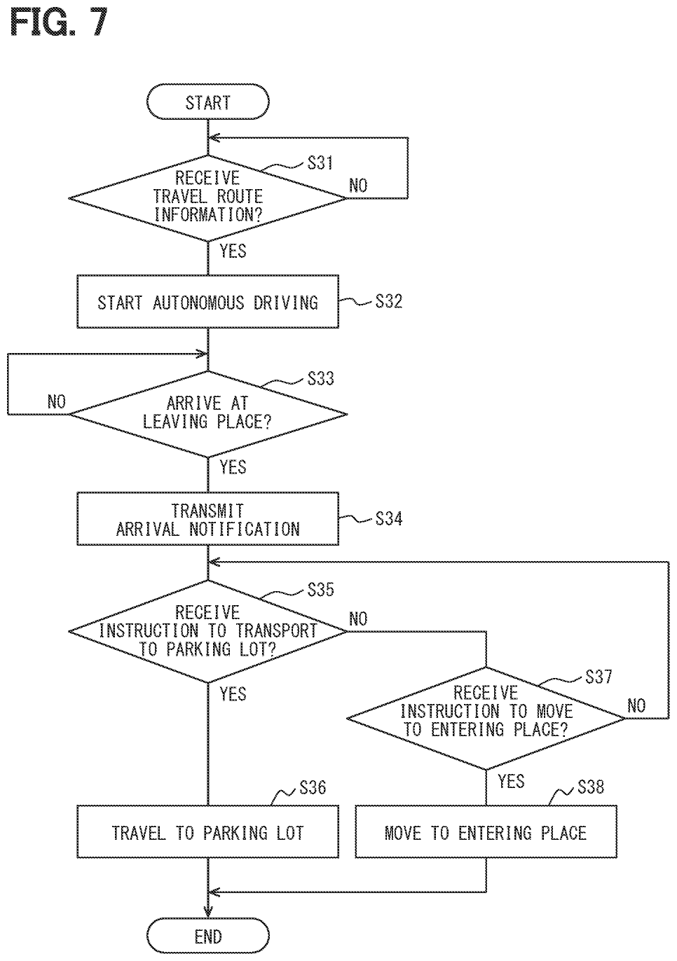

A first leaving execution process executed by the automated guided vehicle 21 will be described with reference to FIG. 7. The first leaving execution process is a process of transporting the vehicle 18 from the parking position to the leaving place 5 in response to the first leaving control process. Here, a case will be described in which the automated guided vehicle 21 waiting in the vicinity of the first parking lot 7 transports the vehicle 18 parked in the first parking lot 7.

In S31, the controller 61 determines whether or not the communication unit 67 has received the travel route information. The travel route information is transmitted by the management device 39 in S22. The communication unit 67 receives, for example, the travel route information representing the first travel route from the current position to the parking position and the second travel route from the parking position to the leaving place 5 through the first passage 11. When the travel route information has been received, the process proceeds to S32. When the travel route information has not been received, the process returns to a state before S31.

In S32, the controller 61 starts the autonomous driving by using the travel route information and the map information held in advance. Based on the received travel route information, the automated guided vehicle 21 travels on the first passage 11. The direction in which the automated guided vehicle 21 mounted with the vehicle 18 travels is always the first direction D1 shown in FIG. 1.

In S33, the controller 61 determines whether or not the automated guided vehicle 21 has arrived at the leaving place 5. When the automated guided vehicle 21 has arrived at the leaving place 5, the process proceeds to S34. When the automated guided vehicle 21 has not yet arrived at the leaving place 5, the process returns to a state before S33.

In S34, the controller 61 uses the communication unit 67 to transmit the arrival notification. The management device 39 receives the transmitted arrival notification.

In S35, the controller 61 determines whether or not the communication unit 67 has received transportation instruction to the first parking lot 7. The transportation instruction to the first parking lot 7 is transmitted by the management device 39 in S28. As the transport instruction, the communication unit 67 receives, for example, travel route information indicating a travel route from the leaving place 5 to the parking position in the first parking lot 7 through the second passage 13. When the transportation instruction to the first parking lot 7 has been received, the process proceeds to S36. When the transportation instruction to the first parking lot 7 has not been received, the process proceeds to S37.

In S36, the automated guided vehicle 21 causes the automated guided vehicle 21 to travel to the first parking lot 7 based on the received travel route information in the mounting state. As a result, the automated guided vehicle 21 transports the vehicle 18 from the leaving place 5 to the first parking lot 7.

In S37, the controller 61 determines whether or not the communication unit 67 has received the instruction to move to the entering place 3. The instruction to move to the entering place 3 is transmitted by the management device 39 in S27. As the instruction to move, the communication unit 67 receives, for example, travel route information indicating a travel route from the leaving place 5 to the entering place 3 through the second passage 13.

In S38, the controller 61 moves the automated guided vehicle 21 that has been separated from the vehicle 18 from the leaving place 5 to the entering place 3 through the second passage 13. The traveling direction of the automated guided vehicle 21 in the second passage 13 is always the second direction D2 shown in FIG. 1.

7. Second Parking Control Process Executed by the Management Device 39

A second parking control process executed by the management device 39 will be described. The second parking control process is a process of transporting the vehicle 18B from the entering place 3 to the first parking lot 7 or the second parking lot 9 through at least a part of the first passage 11 and parking the vehicle 18B.

The second parking control process is started when the first terminal 43 outputs the parking request signal and the identification information of the vehicle 18B to the management device 39.

The situation when the first terminal 43 outputs the parking request signal and the identification information of the vehicle 18B to the management device 39 is as follows, for example. The vehicle 18B to be parked enters the entering place 3 and stops. Next, the occupant 25 gets off the vehicle 18B, performs an input operation corresponding to the parking request signal to the first terminal 43, and inputs the identification information of the vehicle 18B.

The second parking control process is basically similar to the first parking control process. However, in the second parking control process, the vehicle 18B is controlled instead of the automated guided vehicle 21. That is, the vehicle 18B is a vehicle having an autonomous driving function similar to the automated guided vehicle 21. Further, in the second parking control process, in addition to the travel route information, the map information inside the parking lot system 1 is also supplied in S3. The vehicle 18B uses the supplied map information when performing autonomous driving.

8. Second Parking Execution Process Executed by the Vehicle 18B

A second parking execution process executed by the vehicle 18B will be described. The second parking execution process is a process in which the vehicle 18B travels from the entering place 3 to the parking position in response to the second parking control process. The vehicle 18B receives from the management device 39 travel route information indicating a travel route from the entering place 3 to the parking position in the first parking lot 7 through the first passage 11. In the second parking execution process, the vehicle 18B travels in the first passage 11 based on the received travel route information. The direction in which the vehicle 18B travels in the second parking execution process is always the first direction D1 shown in FIG. 1.

The second parking execution process is basically similar to the first parking execution process. The controller 69 performs processing similar to the controller 61. The sensor group 71 performs processing similar to the sensor group 63. The position information acquisition unit 73 performs processing similar to the position information acquisition unit 65. The communication unit 75 performs processing similar to the communication unit 67.

However, the vehicle 18B receives the map information inside the parking lot system 1 from the management device 39 in addition to the travel route information. The vehicle 18B uses the received map information when performing autonomous driving.

9. Second Leaving Control Process Executed by the Management Device 39

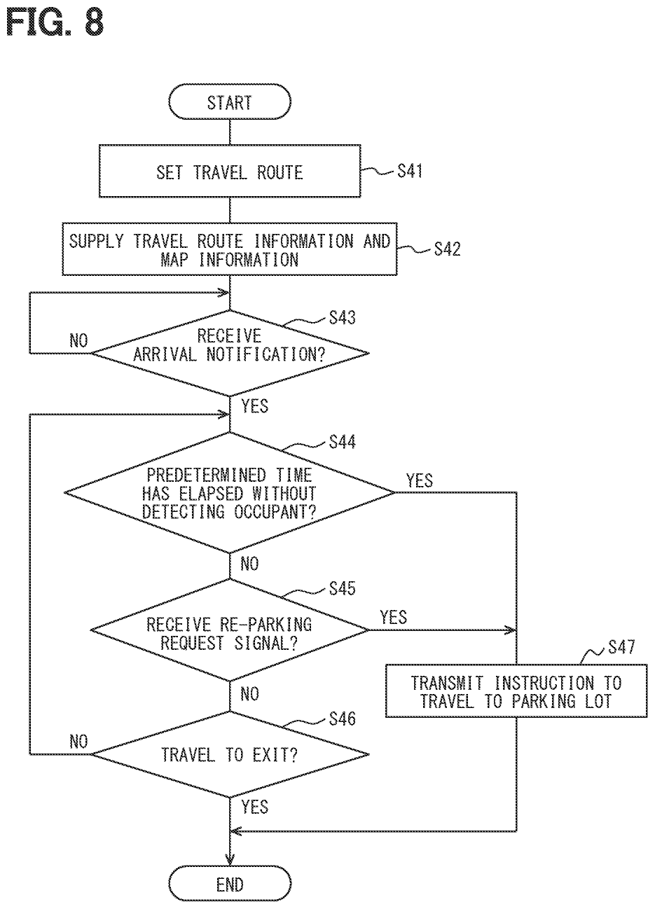

A second leaving control process executed by the management device 39 will be described with reference to FIG. 8. The second leaving control process is a process of driving the vehicle 18B from the parking position to the leaving place 5 through at least a part of the first passage 11.

The second leaving control process is started when the management device 39 determines that a trigger for leaving has occurred. Cases where the management device 39 determines that the trigger of delivery has occurred include following third situation and fourth situation.

(Third Situation)

The occupant 25 performs an input operation corresponding to the leaving request signal to the second terminal 45, and inputs the identification information of the vehicle 18B. The second terminal 45 outputs the leaving request signal and the identification information of the vehicle 18B to the management device 39. The management device 39 determines that the trigger for leaving has occurred.

(Fourth Situation)

The occupant 25 makes a reservation for leaving to the management device 39 using a mobile terminal or the like. The reservation for leaving is made by designating a reservation time for leaving and the identification information of the vehicle 18B. When the reserved time arrives, the management device 39 determines that the trigger for leaving has occurred.

In the following description of the second leaving control process and the description of the second leaving execution process described later, the vehicle 18B is the vehicle 18B corresponding to the input identification information unless otherwise specified.

In S41, the transport control unit 55 sets a travel route from the parking position of the vehicle 18B to the leaving place 5 using the map information.

In S42, the transport control unit 55 transmits the travel route information representing the travel route set in S41 and the map information by using the communication unit 49. As will be described later, the vehicle 18B receives the travel route information and the map information.

In S43, the movement control unit 57 determines whether or not the communication unit 49 has received an arrival notification. The arrival notification is a notification transmitted by the vehicle 18B when the vehicle 18B arrives at the leaving place 5. When the arrival notification has been received, the process proceeds to S44. When the arrival notification has not been received, the process returns to a state before S43.

In S44, the movement control unit 57 determines whether or not a predetermined time has elapsed from a time when the arrival notification is received without detecting the occupant 25 at the leaving place 5. The movement control unit 57 can detect the occupant 25 by using the infrastructure 41. When the predetermined time has elapsed from the time when the arrival notification is received without detecting the occupant 25 at the leaving place 5, the process proceeds to S47. When the occupant 25 is detected or the predetermined time has not yet elapsed, the process proceeds to S45.

In S45, the movement control unit 57 determines whether or not the re-parking request signal or the like has been received from the second terminal 45. When the re-parking request signal or the like has been received, the process proceeds to S46. When the re-parking request signal or the like has not been received, the process proceeds to S47.

In S46, the movement control unit 57 determines whether or not the vehicle 18B has traveled in the direction toward the exit 27. The movement control unit 57 can determine whether or not the vehicle 18B has traveled in the direction toward the exit 27 based on the information supplied by the infrastructure 41. When the vehicle 18B has traveled in the direction toward the exit 27, the process ends. If the vehicle 18B has not traveled in the direction toward the exit 27, the process proceeds to S44.

In S47, the movement control unit 57 transmits an instruction to travel to the first parking lot 7 or the second parking lot 9 to the vehicle 18B by using the communication unit 49.

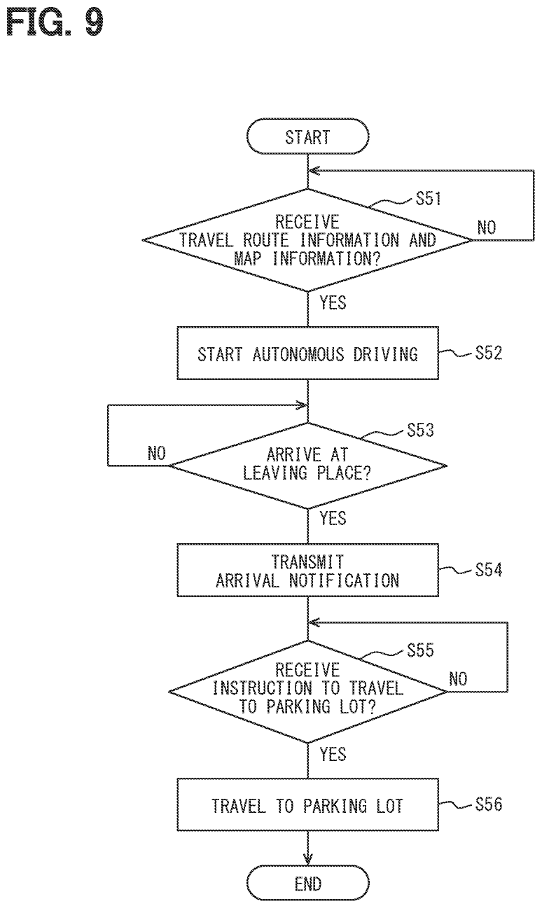

10. Second Leaving Execution Process Executed by Vehicle 18B A second leaving execution process executed by the vehicle 18B will be described with reference to FIG. 9. The second leaving execution process is a process of traveling the vehicle 18B from the parking position to the leaving place 5 in response to the second leaving control process.

In S51, the controller 69 determines whether or not the communication unit 75 has received the travel route information and the map information. The travel route information and the map information are transmitted by the management device 39 in S42. When the travel route information and the map information has been received, the process proceeds to S52. When the travel route information and the map information have not been received, the process returns to a state before S51.

In S52, the controller 69 starts autonomous driving using the travel route information and the map information. By autonomous driving, the vehicle 18B travels in the first passage 11. The direction in which the vehicle 18B travels is always the first direction D1 shown in FIG. 1.

In S53, the controller 69 determines whether or not the vehicle 18B has arrived at the leaving place 5. When the vehicle 18B has arrived at the leaving place 5, the process proceeds to S54. When the vehicle 18B has not yet arrived at the leaving place 5, the process returns to a state before S53.

In S54, the controller 69 uses the communication unit 75 to transmit the arrival notification. The management device 39 receives the transmitted arrival notification.

In S55, the controller 69 determines whether or not the communication unit 75 has received the instruction to travel to the parking lot. The instruction to travel to the parking lot is transmitted by the management device 39 in S47. When the instruction to travel to the parking lot has been received, the process proceeds to S56. When the instruction to travel to the parking lot has not been received, the process returns to a state before S55.

In S56, the controller 69 causes the vehicle 18B to travel to the first parking lot 7 or the second parking lot 9.

11. Effects of the Parking Lot System 1

(1A) In the parking lot system 1, the automated guided vehicle 21 that is transporting the vehicle 18 to the first parking lot 7 or the second parking lot 9 and the vehicle 18B that is traveling to the first parking lot 7 or the second parking lot 9 travel in the first passage 11. Further, the automated guided vehicle 21 that is transporting the vehicle 18 to the leaving place 5 and the vehicle 18B that is traveling to the leaving place 5 travel in the first passage 11.

In the parking lot system 1, the automated guided vehicle 21 which has been separated from the vehicle 18 and moves from the leaving place 5 to the entering place 3 travels in the second passage 13. In the parking lot system 1, the first passage 11 and the second passage 13 are separated.

Therefore, according to the parking lot system 1, it is unlikely that the automated guided vehicle 21 transporting the vehicle 18 and the vehicle 18B travel in the same passage as the automated guided vehicle 21 separated from the vehicle 18. As a result, the parking lot system 1 can suppress congestion in the first passage 11 and the second passage 13, and can efficiently park and leave the vehicles 18.

(1B) The parking lot system 1 limits the traveling direction of the automated guided vehicle 21 and the vehicle 18B in the first passage 11 to the first direction D1. Further, the parking lot system 1 limits the traveling direction of the automated guided vehicle 21 in the second passage 13 to the second direction D2. Therefore, the parking lot system 1 can further suppress congestion in the first passage 11 and the second passage 13.

(1C) The width of the first passage 11 and the width of the second passage 13 are each equal to or less than twice the width of the automated guided vehicle 21. Therefore, the area occupied by the parking lot system 1 can be suppressed.

(1D) The parking lot system 1 can detect the states of the first parking lot 7 and the second parking lot 9. When the first parking lot 7 and the second parking lot 9 are full, the parking lot system 1 sets the area on the first passage 11 or the second passage 13 as the parking position. Therefore, when the first parking lot 7 and the second parking lot 9 are full, the parking lot system 1 transports the vehicle 18 to the area on the first passage 11 or the second passage 13 and parks the vehicle 18. As a result, the parking system 1 can park more vehicles 18. Full means that all the sections in the first parking lot 7 and the second parking lot 9 are occupied.

### Second Embodiment

1. Differences From the First Embodiment

Since the basic configuration of a second embodiment is similar to the first embodiment, differences will be described below. Note that the same reference numerals as those in the first embodiment indicate the same configuration, and refer to the preceding descriptions.

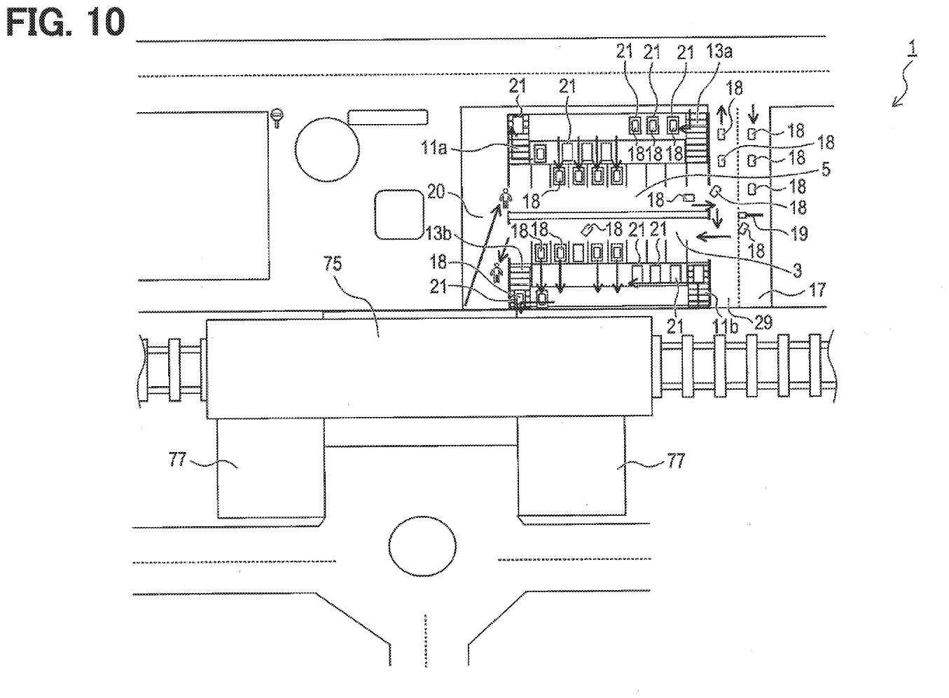

The second embodiment differs from the first embodiment in the following points. As shown in FIG. 10, the parking lot system 1 of the second embodiment is directly connected to a station 75 and a station building 77. The entering place 3 is located adjacent to the station 75, and the leaving place 5 is located on a side opposite from the station 75. Further, the parking lot system 1 of the second embodiment is a three-dimensional parking lot system, and includes a floor where the entering place 3 and the leaving place 5 are located (hereinafter referred to as an A floor), and a floor where the first parking lot 7 and the second packing lot 9 are located (hereinafter referred to as a B floor). The A floor may be a floor above the B floor or a floor below the B floor. The A floor is, for example, the first floor. The B floor is, for example, the second to fifth floors.

The setting unit 54 sets a first passage 11a on each of the A floor and the B floor. The position of the first passage 11a on each of the A floor and the B floor is an upper left position and is a position on an outer peripheral side of the parking lot system 1 in FIG. 10.

The setting unit 54 sets a first passage 11b on each of the A floor and the B floor. The position of the first passage 11b on each of the A floor and the B floor is a lower right position and is a position on the outer peripheral side of the parking lot system 1 in FIG. 10.

The position of the first passage 11a on each of the A floor and the B floor and the position of the first passage 11b on each of the A floor and the B floor are on the diagonal line of the parking lot system 1.

The first passage 11a on the A floor and the first passage 11a on the B floor are connected by a slope or an elevator. The first passage 11b on the A floor and the first passage 11b on the B floor are connected by a slope or an elevator.

The setting unit 54 sets a second passage 13a on each of the A floor and the B floor. The position of the second passage 13a on each of the A floor and the B floor is an upper right position and is a position on the outer peripheral side of the parking lot system 1 in FIG. 10.

The setting unit 54 sets a second passage 13b on each of the A floor and the B floor. The position of the second passage 13b on each of the A floor and the B floor is a lower left position and is a position on the outer peripheral side of the parking lot system 1 in FIG. 10.

The position of the second passage 13a on each of the A floor and the B floor and the position of the second passage 13b on each of the A floor and the B floor are on the diagonal line of the parking lot system 1.

The second passage 13a on the A floor and the second passage 13a on the B floor are connected by a slope or an elevator. The second passage 13b on the A floor and the second passage 13b on the B floor are connected by a slope or an elevator.

In the present embodiment, the first passage 11a and the second passage 13a are one-way passages that permits travel only in the downward direction. The first passage 11b and the second passage 13b are one-way passages that permits travel on in the upward direction. The setting unit 54 sets the positions and the traveling direction of the first passages 11a, 11b and the second passages 13a, 13b according to the relationship between the A floor where the entering place 3 and the leaving place 5 are located and the B floor where the first parking lot 7 and the second parking lot 9 are located. A pedestrian-only area 20 connects the entering place 3 and the leaving place 5 with the station 75.

When the automated guided vehicle 21 mounted with the vehicle 18 travels from the entering place 3 to the parking position in the first parking lot 7 or the second parking lot 9, the transport control unit 55 transmits, for example, travel route information indicating a travel route that goes up from the entering place 3 through the first passage 11 and heads for the parking position to the automated guided vehicle 21. When the automated guided vehicle 21 leaves the vehicle 18, for example, the transfer control unit 55 transmits, for example, travel route information indicating a travel route that goes down from the parking position through the first passage 11a and heads for the leaving place 5 to the automated guided vehicle 21. The parking position is, for example, a parking position in the first parking lot 7 or the second parking lot 9 on the third floor.

When the automated guided vehicle 21 that has unloaded the vehicle 18 at the leaving place 5 transports the next entering vehicle 18, the movement control unit 57 transmits, to the automated guided vehicle 21, travel route information indicating a travel route that goes up from the leaving place 5 through the second passages13b, goes down through the second passage 13a, and heads for the entering place 3.

2. Effects of the Parking Lot System 1

According to the second embodiment described in detail above, the following effects are further obtained in addition to the effects of the first embodiment described above.

(2A) In the parking lot system 1 of the second embodiment, the A floor where the entering place 3 and the leaving place 5 are located and the B floor where the first parking lot 7 and the second parking lot 9 are located are different. Therefore, the parking lot system 1 can be constructed even when the site is small.

### Other Embodiments

While the embodiment of the present disclosure has been described above, the present disclosure is not limited to the above embodiments and can be variously modified as exemplified below.

(1) Depending on the time zone and the congestion situation, both the entering place 3 and the leaving place 5 may be temporarily set as the entering place or the leaving place. For example, when the number of vehicles 18 to enter is larger than that of the vehicles 18 to leave, such as immediately after the opening of a store adjacent to the parking lot system 1, both the entering place 3 and the leaving place 5 can be used as the entering place. Further, for example, when the number of vehicles 18 to leave is larger than that of the vehicle 18 to enter, such as when the store adjacent to the parking lot system 1 is about to close, both the entering place 3 and the leaving place 5 may be set as the leaving place.

(2) The first parking lot 7 and the second parking lot 9 may be located on different floors from the entering place 3 and the leaving place 5. In that case, slopes or elevators can be provided in the first passage 11 and the second passage 13.

(3) The first terminal 43 and the second terminal 45 may be terminals that the occupant 25 can carry.

(4) The controller 61 may realize a part or all of the functions of the management device 39.

(5) The first passage 11 and the second passage 13 may pass through the first parking lot 7 and the second parking lot 9.

(6) The parking lot system 1 does not have to include one of the first parking lot 7 or the second parking lot 9.

(7) The controller 47 and method described in the present disclosure may be implemented by a dedicated computer which is configured with a memory and a processor programmed to execute one or more particular functions embodied in computer programs of the memory. Alternatively, the controller 47 and the method according to the present disclosure may be achieved by a dedicated computer which is configured with a processor with one or more dedicated hardware logic circuits. Alternatively, the controller 47 and the method according to the present disclosure may be achieved using one or more dedicated computers which is configured by a combination of a processor and a memory programmed to execute one or more functions and a processor with one or more hardware logic circuits. Further, the computer program may be stored in a computer-readable non-transitory tangible storage medium as instructions to be executed by a computer. The technique for realizing the functions of each unit included in the controller 47 does not necessarily need to include software, and all the functions may be realized using one or a plurality of hardware circuits.

(8) A plurality of functions of one constituent element in the above embodiment may be realized by a plurality of constituent elements, or a single function of one constituent element may be realized by a plurality of constituent elements. Further, multiple functions of multiple elements may be implemented by one element, or one function implemented by multiple elements may be implemented by one element. A part of the configuration of the above embodiments may be omitted. At least a part of the configuration of the above embodiments may be added to or replaced with the configuration of another one of the above embodiments.

(9) The present disclosure can also be realized in various forms such as a higher-level system having the parking lot system 1 as a component, a program for operating a computer as controllers 47, 61, 69, and a non-transitional tangible recording medium such as a semiconductor memory storing the program, a parking support method, and the like, in addition to the parking lot system 1 described above.

What is claimed is:

1. A parking lot system comprising:
an entering place;
a leaving place;
a space;
an automated guided vehicle configured to transport a vehicle; and
a management device configured to control the automated guided vehicle, wherein
the management device includes:
a setting unit configured to set, in the space, a parking lot, a first passage connecting the entering place to the leaving place through the parking lot, and a second passage connecting the leaving place to the entering place;
a transport control unit configured to cause the automated guide vehicle to transport the vehicle from the entering place to the parking lot through at least a part of the first passage, and transport the vehicle from the parking lot to the leaving place through at least another part of the first passage;
a movement control unit configured to cause the automated guided vehicle to travel from the leaving place to the entering place through the second passage; and
a detection unit configured to detect a state of the parking lot,
the first passage and the second passage are divided from each other, and
the transport control unit is further configured to cause the automated guide vehicle to transport the vehicle to the first passage or the second passage in response to the detection unit detecting that the parking lot is full.

2. The parking lot system according to claim 1, wherein
the transport control unit limits a traveling direction of the automated guided vehicle in the first passage to a first direction, and
the movement control unit limits a traveling direction of the automated guided vehicle in the second passage to a second direction.

3. The parking lot system according to claim 1, wherein
a width of each of the first passage and the second passage is equal to or less than twice a width of the automated guided vehicle.

4. The parking lot system according to claim 1, further comprising:
a pedestrian-only area connecting the entering place or the leaving place to a facility.

5. The parking lot system according to claim 1, wherein
the movement control unit is configured to cause the automated guided vehicle to wait in a vicinity of the entering place when the automated guided vehicle is not in use.

6. The parking lot system according to claim 1, wherein
the transport control unit is further configured to cause the automated guided vehicle to transport the vehicle to the parking lot through the second passage in response to that a predetermined time has elapsed without detecting an occupant at the leaving place from a time when the vehicle transported by the automated guided vehicle arrives at the leaving place.

7. A management device for managing an automated valet parking using an automated guided vehicle capable of transporting a vehicle in a parking lot facility that includes an entering place, a leaving place, and a space, the management device comprising:
a setting unit configured to set, in the space, a parking lot, a first passage connecting the entering place to the leaving place through the parking lot, and a second passage connecting the leaving place to the entering place;
a transport control unit configured to cause the automated guide vehicle to transport the vehicle from the entering place to the parking lot through at least a part of the first passage, and transport the vehicle from the parking lot to the leaving place through at least another part of the first passage;
a movement control unit configured to cause the automated guided vehicle to travel from the leaving place to the entering place through the second passage; and
a detection unit configured to detect a state of the parking lot, wherein
the first passage and the second passage are divided from each other, and
the transport control unit is further configured to cause the automated guide vehicle to transport the vehicle to the first passage or the second passage in response to the detection unit detecting that the parking lot is full.

8. The management device according to claim 7, wherein
the transport control unit is further configured to cause the automated guided vehicle to transport the vehicle to the parking lot through the second passage in response to that a predetermined time has elapsed without detecting an occupant at the leaving place from a time when the vehicle transported by the automated guided vehicle arrives at the leaving place.

9. A parking lot facility in which automated valet parking using an automated guided vehicle capable of transporting a vehicle is managed by a management device, the parking lot facility comprising:
an entering place;
a leaving place;
a parking lot;
a first passage connecting the entering place to the leaving place through the parking lot, and being a passage on which the automated guided vehicle travels when transporting the vehicle from the leaving place to the parking lot, and when transporting the vehicle from the parking lot to the leaving place; and
a second passage connecting the leaving place to the entering place, divided from the first passage, and being a passage on which automated guided vehicle travels when moving from the leaving place to the entering place, wherein
the first passage and the second passage surround the parking lot.

10. The parking lot system according to claim 1, wherein
the management device includes a processor and a memory, the memory storing instructions configured to, when executed by the processor, cause the processor to implement the setting unit, the transport control unit, the movement control unit, and the detection unit.

11. The management device according to claim 7, further comprising:
a processor and a memory, the memory storing instructions configured to, when executed by the processor, cause the processor to implement the setting unit, the transport control unit, the movement control unit, and the detection unit.
